(19) United States
(12) Patent Application Publication
(10) Pub. No.: US 2017/0169432 A1
(43) Pub. Date: Jun. 15, 2017

(54) SYSTEM AND METHOD OF IDENTIFYING BAKER'S FRAUD IN TRANSACTIONS

(71) Applicant: MASTERCARD INTERNATIONAL INCORPORATED, Purchase, NY (US)

(72) Inventors: Ravi Santosh ARVAPALLY, O'Fallon, MO (US); David SENCI, Troy, IL (US); Peng YANG, Chesterfield, MO (US); Christopher John MERZ, Wildwood, MO (US)

(21) Appl. No.: 14/970,197

(22) Filed: Dec. 15, 2015

(51) Int. Cl. G06Q 20/40

(52) U.S. Cl. CPC G06Q 20/4016

(57) ABSTRACT

A system, method, and computer-readable storage medium configured to identify and prevent a form of fraud in payment transactions.

### BACKGROUND

Field of the Disclosure

Aspects of the disclosure relate in general to commercial services. Aspects include a method and analysis platform to identify and prevent a form of fraud in payment transactions.

Description of the Related Art

A payment card is a card that can be used by an accountholder and accepted by a merchant to make a payment for a purchase or in payment of some other obligation. Payment cards include credit cards, debit cards, charge cards, and Automated Teller Machine (ATM) cards. Payment cards provide the clients of a financial institution (“accountholders”) with the ability to pay for goods and services without the inconvenience of using cash.

However, in unscrupulous hands, payment cards are used in potential fraud or money laundering.

Merchants in a few countries lend cash to accountholders by treating a credit card transaction as an assurance or surety. During this transaction, merchants provide cash to an accountholder instead of goods. Merchants perform this only when the merchant is very familiar with the accountholder. By such a transaction, merchants deduct a commission from the transaction amount, and the percentage of commission depends on merchant and accountholder understanding. This activity occurs mostly in small chain or non-chain grocery stores and it is unknown whether this type of activity occurs in other business verticals. Accountholders use the obtained cash from the merchant for short-term trading, micro-financing, and other activities. At the same time, the accountholder ensures to pay back to the issuing bank in time to avoid default problems.

When merchants and accountholders perform this type of transaction, they are misusing payment networks, using a payment card in an illegal manner, and violating the law in the merchant-located country. This type of fraud can be viewed as a form of money-laundering, which is a crime according to international norms. The assumption is that this type of fraud primarily occurs in countries where cash is primary source of payment in business. In addition, both issuers and acquirer are unaware of this irregularity, and there is no way that a merchant or an accountholder reports this type of fraud. Because this type of fraud was first discovered at a bakery it is called “Baker's fraud.”

### SUMMARY

Embodiments include a system, device, method and computer-readable medium to identify and prevent a form of fraud in payment transactions.

The system includes a network interface, and a processor. The network interface receives a payment authorization request. The payment authorization request describes the payment transaction and contains: a payment authorization accountholder identifier, a payment authorization merchant identifier, a payment authorization transaction timestamp, and a payment authorization transaction amount in local currency. The system retrieves merchant transaction data from a database based on a merchant identified by the payment authorization merchant identifier. The merchant transaction data is stored on a non-transitory computer-readable storage medium. The merchant transaction data includes a plurality of past merchant transaction entries. Each of the past transaction entries comprises: a past transaction accountholder identifier, and a past transaction amount in local currency. The system retrieves accountholder transaction data from the database based on an accountholder identified by the payment authorization accountholder identifier. The accountholder transaction data includes a plurality of past accountholder transaction entries. Each of the past accountholder transaction entries comprises: a past transaction merchant identifier, a past accountholder transaction timestamp, and a past accountholder transaction amount in local currency. When the payment authorization request transaction amount is a multiple of 1000 and exceeds a predetermined threshold amount, the processor scores the merchant based on the plurality of past transaction entries resulting in a merchant score, and scores the accountholder based on the plurality of past accountholder transaction entries resulting in an accountholder score. The processor then scores the payment transaction based on the merchant score and the accountholder score resulting in a Baker's Fraud score. The network interface transmits to an issuer associated with the payment authorization accountholder identifier an alert with the network interface when the Baker's Fraud score exceeds a predetermined Baker's Fraud threshold.

### BRIEF DESCRIPTION OF THE DRAWINGS

FIG. 1 is a block diagram illustrating a payment system to identify and prevent a form of fraud in payment transactions.

FIG. 2 is an expanded block diagram of an exemplary embodiment of a server architecture of a payment network embodiment configured to identify and prevent a form of fraud in payment transactions.

FIGS. 3A-B illustrate a real time authorization process, from the perspective of a payment network, to identify and prevent a form of fraud in payment transactions.

FIG. 4 depicts a merchant scoring process, from the perspective of a payment network, to identify and prevent a form of fraud in payment transactions.

FIG. 5 is a flowchart of a customer scoring process, from the perspective of a payment network, to identify and prevent a form of fraud in payment transactions.

FIG. 6 illustrates an alternate process to identify and prevent a form of fraud in payment transactions.

### DETAILED DESCRIPTION

One aspect of the disclosure includes the realization that Baker's fraud is detectable by a payment network, and may be detected during a real-time payment authorization transaction, which would allow prevention of the fraud.

Another aspect of the disclosure is the realization that accountholder and merchant data would be needed to detect Baker's fraud.

The systems and processes are not limited to the specific embodiments described herein. In addition, components of each system and each process can be practiced independently and separately from other components and processes described herein. Each component and process also can be used in combination with other assembly packages and processes.

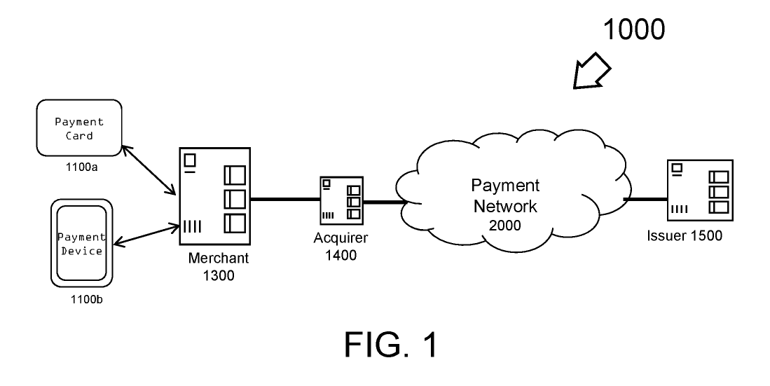

FIG. 1 is a block diagram 1000 illustrating a system and method to identify and prevent a form of fraud in payment transactions. The present disclosure is related to a payment system, such as a credit card payment system using a payment network 2000, such as the MasterCard® interchange, Cirrus® network, or Maestro®. The MasterCard interchange is a proprietary communications standard promulgated by MasterCard International Incorporated of Purchase, New York, for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system 1000, a financial institution called the “issuer” 1500 issues a payment account to a consumer, who uses payment device 1100a-v to tender payment for a purchase from merchant 1300. Payment devices may include a payment card 1100a, or mobile device 1100b (such as key fobs, mobile phones, tablet computers, Personal Digital Assistants (PDAs), electronic wallets and the like. Payment devices may be used to tender purchase in-person at merchant 1300.

In this example, a consumer makes a purchase at merchant 1300; the merchant 1300 in turn gives the consumer cash in the approximate amount of the purchase, minus a fee. During the transaction, the consumer presents the payment device 1100 to a point-of-sale device at merchant 1300. The merchant 1300 is affiliated with a financial institution. This financial institution is usually called the “merchant bank,” “acquiring bank” “acquirer bank,” or acquirer 1400. When a payment device 1100 is tendered at merchant 1300, the merchant 1300 electronically requests authorization from the acquirer 1400 for the amount of the purchase. The authorization request is performed electronically with the consumer's account information. For payment cards, the consumer's account information may be retrieved from the magnetic stripe on a payment card 1100a or via a computer chip imbedded within the card 1100a. For other types of payment devices 1100b, the consumer's account information may be retrieved by wireless methods, such as contactless communication like MasterPass® or via Near Field Communication (NFC). The account information, along with the transaction information, is forwarded to transaction processing computers of the acquirer 1400. Alternatively, an acquirer 1400 may authorize a third party to perform transaction processing on its behalf. In this case, the merchant 1300 will be configured to communicate with the third party. Such a third party is usually called a “merchant processor” or an “acquiring processor” (not shown).

The computers of the acquirer 1400 or the merchant processor will communicate, via payment network 2000, with the computers of the issuer 1500 to determine whether the consumer's account is in good standing and whether the accountholder should be approved for the purchase. It is understood that any number of issuers 1500 may be connected to payment network 2000.

Based on the details of the transaction, a history of the transactions at the merchant, and the consumer's past purchase history, the payment network 2000 retrieves accountholder data to determine whether the transaction raises suspicion of Baker's fraud. When the transaction is suspicious, the payment network 2000 either blocks the transaction automatically, or informs the issuer 1500 of the likelihood of Baker's fraud. In the latter situation, the issuer 1500 can deny the transaction.

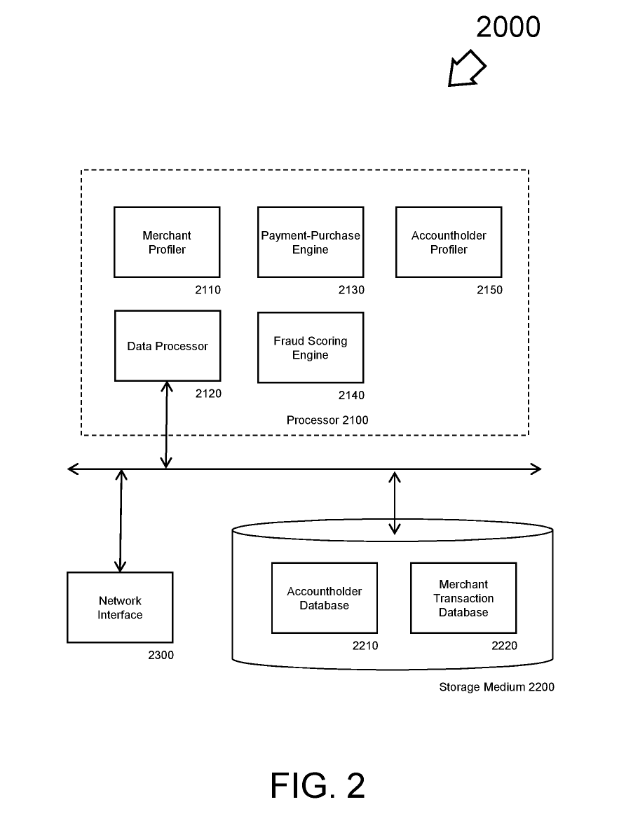

Embodiments will now be disclosed with reference to a block diagram of an exemplary payment network server 2000 of FIG. 2, configured to identify and prevent a form of fraud in payment transactions, constructed and operative in accordance with an embodiment of the present disclosure. While payment network server 2000 is described as being part of payment network, it is understood that in some embodiments the payment network server described herein could be located at an issuer 1500.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a merchant profiler 2110, a payment-purchase engine 2130, a data processor 2120, a fraud scoring engine 2140, and a accountholder profiler 2150.

Data processor 2120 interfaces with storage medium 2200 and network interface 2300. The data processor 2120 enables processor 2100 to locate data on, read data from, and writes data to, these components.

Payment-purchase engine 2130 performs payment and purchase transactions, and may do so in conjunction with merchant profiler 2110.

Merchant profiler 2110 is the structure that models merchant 1300 transactions based on previous transactions at the merchant 1300. The previous transaction information is captured by the payment network 2000 and stored in a merchant transaction database 2220.

Accountholder profiler 2150 is the structure that models accountholder transactions based on previous transactions made by the accountholder. The previous transaction information is captured by the payment network 2000 and stored in an accountholder database 2210.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain an accountholder database 2210 and a merchant transaction database 2220. Accountholder database 2210 contains information about an accountholder, including payment accounts (and their Primary Account Numbers) associated with an accountholder, an account transaction history, and any information collected by payment network 2000. Merchant transaction database 2220 is configured to store a merchant transaction history at a merchant 1300.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with acquirer 1400 and issuer 1500.

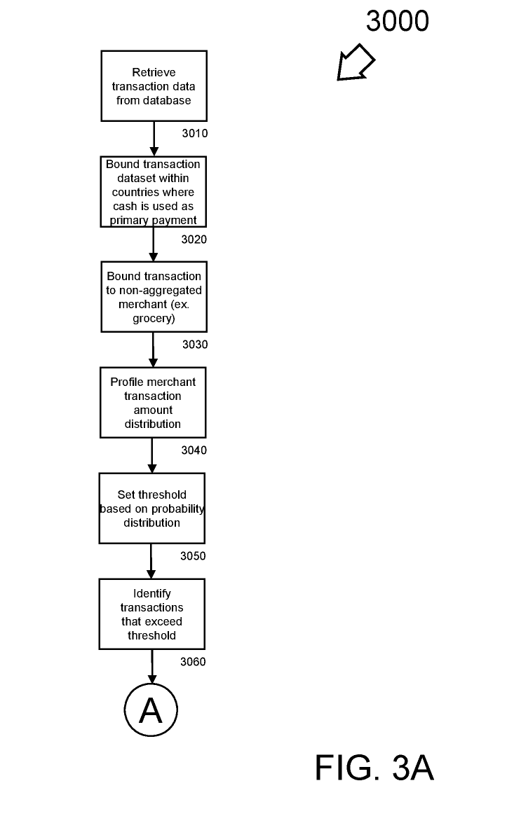

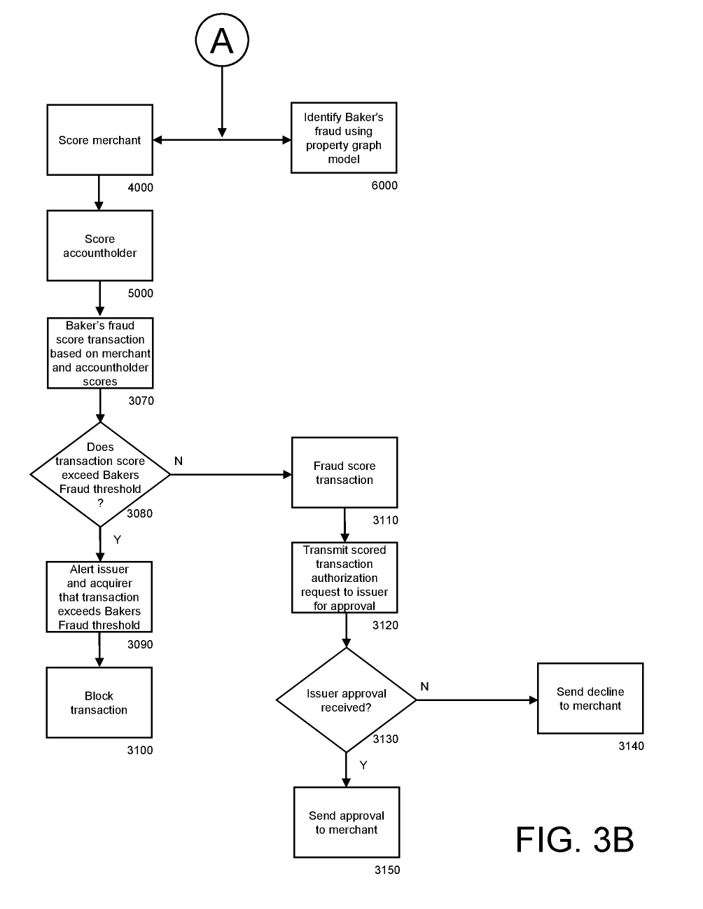

We now turn our attention to a method or process embodiment of the present disclosure, FIGS. 3A-3B, 4, 5, and 6. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIGS. 3A-3B illustrate a process 3000, from the perspective of a payment network server 2000, to identify and prevent a form of fraud in a purchase transaction, constructed and operative in accordance with an embodiment of the present disclosure. It is understood by those familiar with the art that process 3000 is a real-time authentication process.

As part of a purchase transaction, a customer makes a purchase at a merchant 1300, which may or may not be a Baker's fraud transaction. In a fraud transaction, a merchant 1300 gives the consumer cash in the approximate amount of the purchase, minus a fee. The consumer presents the payment device 1100 to a point-of-sale device at merchant 1300, which begins to process the transaction, by sending purchase transaction authorization request to acquirer 1400, which in turn sends it to payment network 2000.

At block 3010, payment network 2000 receives a purchase transaction authorization request from the acquirer 1400. The transaction authorization request is received electronically via a network interface 2300, and contains transaction data including: an account identifier for a payment account (which can be a Primary Account Number), a merchant identifier, an amount of the transaction, and a transaction type (purchase, return, cash-advance,) transaction time-stamp, merchant location (street address, state, country, postal code) and the like.

Fraud scoring engine 2140 bounds the transaction dataset within countries where cash is used as primary payment, block 3020. In some embodiments, fraud scoring engine 2140 compares the merchant identifier to determine the location of merchant 1300, and compares the location to a list of pre-determined countries. If the transaction is not occurring at a merchant 1300 within a country where cash is used as primary payment, then process 3000 does not apply.

The merchant transactions are profiled based on amount distribution, block 3040. To create a profile for the filtered merchants, the probability distribution of the merchants' transaction amounts. Historical transaction amounts are collected for each merchant 1300. A probability distribution (for example, t Location-Scale) is made to fit the data and obtain parameters of the probability density function. Thresholds are set based on the probability distribution, to identify suspicious transactions, block 3050. The merchant location ID, the estimated parameters, as well as the thresholds are then recorded in a merchant profile table, along with metadata including date of update and the like.

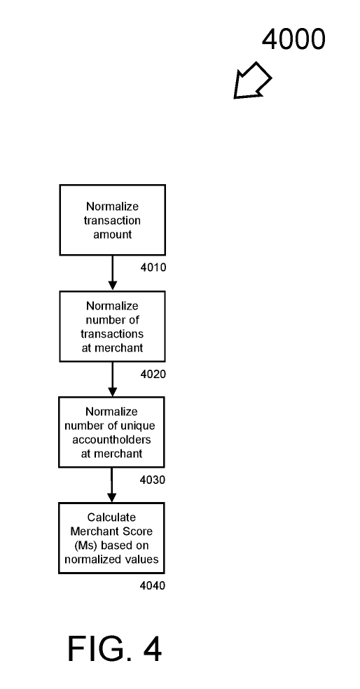

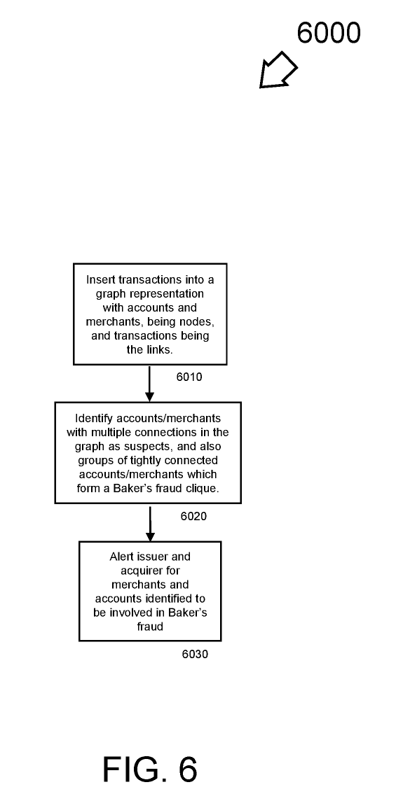

Transaction nodes (which represent the merchant transactions) that exceed the threshold are identified, block 3060. After creation of the merchant transaction profiles, transactions are tested against the threshold, and suspicious transactions are collected. From block 3060, the process 3000 flows into both process 4000, described in FIG. 4, and process 6000, described in FIG. 6.

The merchant is scored by the merchant profiler 2110 by process 4000, as described in FIG. 4, constructed and operative in accordance with an embodiment of the present disclosure. The information used in scoring a merchant 1300 is retrieved by the merchant profiler 2110 from the merchant transaction database 2220. The following information of a derived dataset (as filtered by blocks 3010-3060) is used: transaction amount at a merchant, the number of transactions at a merchant, and the number of unique cardholders a merchant is entertaining.

At block 4010, the merchant profiler 2110 normalizes the transaction amount. The transaction amount at a merchant 1300 is the total transaction amount at the merchant 1300 for a given period of time within a derived dataset. Min-max normalization is used to transform the data to a range of 0 to 1.

The number of transactions is normalized by the merchant profiler 2110, block 4020. The number of transactions at a merchant is the total number of transactions at a merchant 1300 for a given period of time within the derived dataset. Min-max normalization is used.

The number of unique cardholders a merchant is entertaining is normalized by the merchant profiler 2110 using min-max normalization at block 4030.

The three normalized variables are named as A, B and C. Given,

A=Normalized transaction amount at a merchant (Non-aggregated grocery merchants)

B=Normalized number of transactions at a merchant

C=Normalized number of unique cardholders a merchant is entertaining

the merchant profiler 2110 calculates the merchant score (Ms) based on the normalized values at block 4040. An example calculation may be thought of as:

Ms=(A*0.4)+(B*0.3)+(C*0.3)

Note that the coefficients shown are an example only. In calculating the merchant score, Ms, the coefficients of A, B, and C are assigned based on the importance of the variable, and may be determined empirically. Merchant profiler 2110 may use Analytical Hierarchy Process (AHP) to assign the co-efficient values objectively.

The resulting merchant score ranges from 0 to 1: the higher the value, the greater merchant suspicion in conducting Baker's fraud.

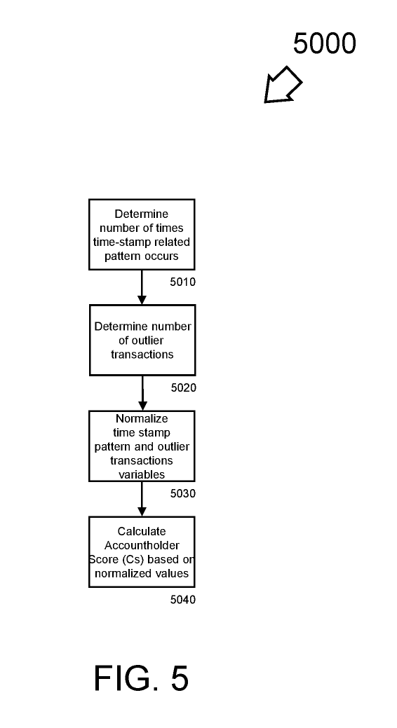

Process 3000 continues, and the accountholder is scored by an accountholder profiler 2150, process 5000. Process 5000 is an accountholder scoring method depicted in FIG. 5, constructed and operative in accordance with an embodiment of the present disclosure.

In process 5000, accountholder profiler 2150 uses past transaction information from the accountholder database 2210 to score the accountholder, resulting in an accountholder score, Cs. It is challenging to identify accountholder information relevant to Baker's fraud, as the accountholders conducting this fraud have a very dynamic behavior and their behavior may be different from another accountholder involved in Baker's fraud. To derive an accountholder score, Cs, one has to perform computing at accountholder level, which may have data usage policies/rules for preserving privacy. Accountholder numbers may be mapped in order to preserve the privacy of accountholders. It is understood that the process 5000 described herein may follow methods for anonymizing/hashing card numbers.

The following accountholder information is used: transaction time-stamp-related patterns, and outlier transactions.

At block 5010, accountholder profiler 2150 examines the accountholder transaction history and determines the number of times a time-stamp related pattern occurs. A transaction's time-stamp related pattern is a pattern based on time. The table provided below presents an example of transaction's time related pattern.

TABLE 1
Example of Time-Related Transaction Pattern

| Transaction | Transaction | Merchant | Transaction | Accountholder |
|---|---|---|---|---|
| Date | Time | Name | Value | Identity |
| Apr. 1, 2015 | 7:18 pm | Tom's Gro- | 5000 | Card-1 |
| | | cery Store | | |
| Apr. 1, 2015 | 7:19 pm | Tom's Gro- | 5000 | Card-1 |
| | | cery Store | | |
| Apr. 1, 2015 | 7:20 pm | Tom's Gro- | 5000 | Card-1 |
| | | cery Store | | |

As shown in Table 1 the same accountholder has spent the same amount at the same merchant on same day. In addition, the time between transactions is brief. These kinds of patterns are identified.

The following is an example of how an example accountholder profiler 2150 embodiment determines the number of times (designated as C) a time-stamp related pattern occurs. In one embodiment, accountholder profiler 2150 tracks different types of transaction time-stamp related patterns—the count of transactions conducted by an accountholder at the same merchant more than three times in a period of one hour (designated as “C1”), and transactions in which the time interval between two transactions of an accountholder at the same merchant is less than a certain time period (designated as “C2”), such as 10 minutes (subjective). Using this measurement, the number of times can be thought of as,

C=(C1*0.5)+(C2*0.5)

At block 5020, the accountholder profiler 2150 calculates the number of outlier transactions (D). There are several types of outlier transactions—deviations from an accountholder's normal spending (D1), deviations from an average amount spent by other accountholders at the same merchant (D2), and deviations based on accountholder spending at non-aggregated merchants (i.e. groceries) over other merchants (D3).

The following illustrates an outlier transaction calculation.

D=(D1*0.2)+(D2*0.4)+(D3*0.4), where

D1=Set to 1, if the highest transaction amount on an accountholder spend history for a month is at least 3 times more than his average monthly spend, or set to 0.

D2=Set to 1, if the transaction amount is at least 3 times more than the average transaction amount of all the transactions at the same merchant, or set to 0.

D3=(Amount spent by an accountholder at non-aggregated grocery merchant in a month)/(Total amount spent by an accountholder in the same month).

After the ‘C’ and ‘D’ scores are computed, the time stamp pattern and outlier transaction scores are normalized using the min-max normalization technique in order to bring consistency, block 5030.

The normalized scores are used to calculate the accountholder score, Cs, where:

Cs=(C*0.6)+(D*0.4)

The higher the accountholder score (Cs) is, the higher the chances that the accountholder is pursuing Baker's fraud.

Returning to FIGS. 3A-3B, the transaction is scored based on the merchant (Ms) and accountholder (Cs) scores, block 3070. The scoring is done from a Baker's fraud perspective, and each transaction is score is computed using the merchant and accountholder scores. In some embodiments, Ts is calculated as the average of the merchant and accountholder scores,

Ts=(0.5*Ms)+(0.5* Cs)

Ts represents the transaction score. The score ranges from 0 to 1, the higher the transaction score is the higher is the chances the transaction is Baker's Fraud.

It is understood that the use of 0.5 as the coefficients is subjective, and that after a sufficient number of transactions are verified to be ‘Baker's Fraud’, those transactions along with legitimate transactions can be used to tune the subjective coefficients used in the initial model, to improve the performance of the scoring system. It is further understood that the coefficients used may be fine-tuned or derived from the process 6000 of FIG. 6, as described below.

If the transaction score exceeds the Baker's fraud threshold, as determined at decision block 3080, then the process continues at block 3090; if the transaction score does not exceed the Baker's fraud threshold, the process continues at block 3110. The threshold may be determined empirically. Initially a score is assigned as Baker's fraud threshold. By analyzing the transactions that are passing the threshold and noting those transactions which are suspicious. By changing the threshold value, block 3080 comes up with a threshold which is reasonable.

At block 3090, the network interface 2300 alerts issuer 1500 and acquirer 1400 that the accountholder's transaction exceeds the Baker's fraud threshold, and the fraud scoring engine 2140 blocks the transaction, block 3100. Process 3000 then ends.

At block 3100, a conventional fraud scoring occurs resulting in a scored transaction authorization request, as is known in the art. The network interface 2300 transmits the scored transaction authorization request to issuer 1500 for approval. If the network interface 2300 receives an issuer approval, as determined at decision block 3130 the transaction, as determined at decision block 3130, the approval is sent to the merchant 1300, block 3150. Otherwise, the decline is sent to the merchant 1300, block 3140.

Process 3000 ends.

FIG. 6 illustrates an alternate non-real-time process 6000 to identify a Baker's fraud in payment transactions, constructed and operative in accordance with an embodiment of the present disclosure.

Process 6000 identifies Baker's fraud by graphing merchant and accountholder transactions.

The non-real-time process 6000 embodiment makes fewer assumptions and therefore can potentially capture suspicious transactions that do not have an even dollar/local currency amount. The transaction filtering is based on all the transactions at a specific merchant. It is also robust to potential data quality issues (e.g., incorrect MCC code). A graph database helps filter out rare but legitimate large transactions, for example, a one-time large purchase from a grocery store. It can also help identify the account-merchant relationship within the Baker's fraud clique.

The process of block 6000 detects cases in which: (1) one merchant is connected to several accountholders, and the merchant is entertaining several accountholders for Baker's fraud; and (2) one accountholders is connected to several merchants conducting Baker's fraud. There may be multiple instances of cases (1) and (2).

The transactions are inserted into a graph representation with accounts and merchants being nodes, and transactions being links, block 6010. These transactions are then fed into a new table or database for further investigation. In some embodiment, a relational database is used to record suspicious transactions. However, other embodiments may use a graph database. In such an embodiment, the nodes will be payment accounts and merchants involved in the suspicious transactions. Each transaction corresponds to a link between an account and a merchant, and at least the following information is included as property of the link:

1. Transaction data and time.

2. Transaction amount (local currency and USD)

With a graph database, the system can identify accounts and merchants with multiple connections in the graph as suspicious, and also groups of tightly connected accounts and merchants that form a Baker's fraud clique, block 6020. Baker's fraud may be identified following specific rules. Note that all the transactions captured in the graph database have unusual transaction amount compared to the other legitimate transactions at the same merchant. The system detects recurring transactions between the same account-merchant pair, or detects a group of merchants and accounts that are involved in many suspicious transactions (and thus forming a clique in the graph).

By querying the graph, and determining how many merchants are entertaining more than a given number of accountholders, and querying how many accountholders are connected to more than a given number of merchants the system can determine whether accountholders or merchants are more responsible for Baker's fraud. This information allows the system to weigh merchant Ms and accountholder scores Cs in the transaction score Ts.

At block 6030, the issuer and acquirer are alerted via the network interface 2300 for merchants and accounts identified as involved in Baker's fraud.

After a certain number of transactions (merchants and accountholders) are identified and suspected to be conducting Baker's fraud, we would plan to use Data Analyst's domain expertise in verifying those transactions and label them to be Baker's fraud. After the labeling process, one may use these labels and explore machine-learning processes for predicting a transaction to be Baker's fraud.

Further, process 6000 may be used to fine-tune the coefficients used in block 3070, as described above.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A real-time method to identify Baker's fraud in a payment transaction, the method comprising:
receiving a payment authorization request with a network interface, the payment authorization request describing the payment transaction and containing: a payment authorization accountholder identifier, a payment authorization merchant identifier, a payment authorization transaction timestamp, and a payment authorization transaction amount in local currency;
retrieving merchant transaction data from a database based on a merchant identified by the payment authorization merchant identifier, the merchant transaction data being stored on a non-transitory computer-readable storage medium, the merchant transaction data including a plurality of past merchant transaction entries, each of the past transaction entries comprising: a past transaction accountholder identifier, and a past transaction amount in local currency;
retrieving accountholder transaction data from the database based on an accountholder identified by the payment authorization accountholder identifier, the accountholder transaction data including a plurality of past accountholder transaction entries, each of the past accountholder transaction entries comprising: a past transaction merchant identifier, a past accountholder transaction timestamp, and a past accountholder transaction amount in local currency;
when the payment authorization request transaction amount exceeds a predetermined threshold amount:
scoring the merchant based on the plurality of past transaction entries resulting in a merchant score, with a processor;
scoring the accountholder based on the plurality of past accountholder transaction entries resulting in an accountholder score, with the processor;
scoring the payment transaction based on the merchant score and the accountholder score resulting in a Baker's Fraud score, with the processor; and,
transmitting to an issuer associated with the payment authorization accountholder identifier an issuer alert with the network interface when the Baker's Fraud score exceeds a predetermined Baker's Fraud threshold.

2. The method of claim 1, wherein scoring the merchant further comprises:
normalizing the payment authorization transaction amount with the processor;
normalizing a number of transactions at the merchant with the processor;
normalizing a number of unique accountholders at the merchant with the processor;
calculating the merchant score, with the processor, based on the normalized payment authorization transaction amount, the normalized number of transactions at the merchant and the normalized number of unique accountholders at the merchant.

3. The method of claim 2, wherein scoring the accountholder further comprises:
determining a number of times a time-stamp related pattern occurrences with the processor;
normalizing the number of times a time-stamp related pattern occurrences with the processor;
determining a number of outlier transactions by the accountholder with the processor;
normalizing number of outlier transactions by the accountholder with the processor;
calculating the accountholder score, with the processor, based on the normalized number of times a time-stamp related pattern occurrences and the normalized number of outlier transactions by the accountholder.

4. The method of claim 3, wherein the merchant is a non-aggregated merchant.

5. The method of claim 4, further comprising:
transmitting to an acquirer associated with the payment authorization merchant identifier an acquirer alert with the network interface when the Baker's Fraud score exceeds a predetermined Baker's Fraud threshold.

6. The method of claim 5, wherein the issuer alert includes the payment authorization accountholder identifier and the Baker's fraud score.

7. The method of claim 6, wherein the acquirer alert includes the payment authorization merchant identifier and the Baker's fraud score.

8. A real-time system to identify Baker's fraud in a payment transaction, the system comprising:
a network interface configured to receive a payment authorization request, the payment authorization request describing the payment transaction and containing: a payment authorization accountholder identifier, a payment authorization merchant identifier, a payment authorization transaction timestamp, and a payment authorization transaction amount in local currency, the network interface further configured to retrieve merchant transaction data from a database based on a merchant identified by the payment authorization merchant identifier, the merchant transaction data being stored on a non-transitory computer-readable storage medium, the merchant transaction data including a plurality of past merchant transaction entries, each of the past transaction entries comprising: a past transaction accountholder identifier, and a past transaction amount in local currency;
a processor configured to retrieve accountholder transaction data from the database based on an accountholder identified by the payment authorization accountholder identifier, the accountholder transaction data including a plurality of past accountholder transaction entries, each of the past accountholder transaction entries comprising: a past transaction merchant identifier, a past accountholder transaction timestamp, and a past accountholder transaction amount in local currency;
when the payment authorization request transaction amount exceeds a predetermined threshold amount, the processor is further configured to:
score the merchant based on the plurality of past transaction entries resulting in a merchant score, with a processor;
score the accountholder based on the plurality of past accountholder transaction entries resulting in an accountholder score, with the processor;
score the payment transaction based on the merchant score and the accountholder score resulting in a Baker's Fraud score, with the processor; and,
the network interface is further configured to transmit to an issuer associated with the payment authorization accountholder identifier an issuer alert with the network interface when the Baker's Fraud score exceeds a predetermined Baker's Fraud threshold.

9. The system of claim 8, wherein scoring the merchant further comprises:
normalizing the payment authorization transaction amount with the processor;
normalizing a number of transactions at the merchant with the processor;
normalizing a number of unique accountholders at the merchant with the processor;
calculating the merchant score, with the processor, based on the normalized payment authorization transaction amount, the normalized number of transactions at the merchant and the normalized number of unique accountholders at the merchant.

10. The system of claim 9, wherein scoring the accountholder further comprises:
determining a number of times a time-stamp related pattern occurrences with the processor;
normalizing the number of times a time-stamp related pattern occurrences with the processor;
determining a number of outlier transactions by the accountholder with the processor;
normalizing number of outlier transactions by the accountholder with the processor;
calculating the accountholder score, with the processor, based on the normalized number of times a time-stamp related pattern occurrences and the normalized number of outlier transactions by the accountholder.

11. The system of claim 10, wherein the merchant is a non-aggregated merchant.

12. The system of claim 11, wherein the network interface is further configured to transmit to an acquirer associated with the payment authorization merchant identifier an acquirer alert with the network interface when the Baker's Fraud score exceeds a predetermined Baker's Fraud threshold.

13. The system of claim 12, wherein the issuer alert includes the payment authorization accountholder identifier.

14. The system of claim 13, wherein the acquirer alert includes the payment authorization merchant identifier.

15. A non-transitory computer-readable medium encoded with data and instructions, when executed by a computing device the instructions cause the computing device to:
receive a payment authorization request with a network interface, the payment authorization request describing a payment transaction and containing: a payment authorization accountholder identifier, a payment authorization merchant identifier, a payment authorization transaction timestamp, and a payment authorization transaction amount in local currency;
retrieve merchant transaction data from a database based on a merchant identified by the payment authorization merchant identifier, the merchant transaction data being stored on a non-transitory computer-readable storage medium, the merchant transaction data including a plurality of past merchant transaction entries, each of the past transaction entries comprising: a past transaction accountholder identifier, and a past transaction amount in local currency;
retrieve accountholder transaction data from the database based on a accountholder identified by the payment authorization accountholder identifier, the accountholder transaction data including a plurality of past accountholder transaction entries, each of the past accountholder transaction entries comprising: a past transaction merchant identifier, a past accountholder transaction timestamp, and a past accountholder transaction amount in local currency;
when the payment authorization request transaction amount exceeds a predetermined threshold amount:
score the merchant based on the plurality of past transaction entries resulting in a merchant score, with a processor;
score the accountholder based on the plurality of past accountholder transaction entries resulting in an accountholder score, with the processor;
score the payment transaction based on the merchant score and the accountholder score resulting in a Baker's Fraud score, with the processor; and,
transmit to an issuer associated with the payment authorization accountholder identifier an issuer alert with the network interface when the Baker's Fraud score exceeds a predetermined Baker's Fraud threshold.

16. The computer-readable storage medium of claim 15, wherein scoring the merchant further comprises:
normalize the payment authorization transaction amount with the processor;
normalize a number of transactions at the merchant with the processor;
normalize a number of unique accountholders at the merchant with the processor;
calculate the merchant score, with the processor, based on the normalized payment authorization transaction amount, the normalized number of transactions at the merchant and the normalized number of unique accountholders at the merchant.

17. The computer-readable storage medium of claim 16, wherein scoring the accountholder further comprises:
determining a number of times a time-stamp related pattern occurrences with the processor;
normalizing the number of times a time-stamp related pattern occurrences with the processor;
determining a number of outlier transactions by the accountholder with the processor;
normalizing number of outlier transactions by the accountholder with the processor;
calculating the accountholder score, with the processor, based on the normalized number of times a time-stamp related pattern occurrences and the normalized number of outlier transactions by the accountholder.

18. The computer-readable storage medium of claim 17, wherein the merchant is a non-aggregated merchant.

19. The computer-readable storage medium of claim 18, further comprising:
transmitting to an acquirer associated with the payment authorization merchant identifier an acquirer alert with the network interface when the Baker's Fraud score exceeds a predetermined Baker's Fraud threshold.

20. The computer-readable storage medium of claim 19, wherein the issuer alert includes the payment authorization accountholder identifier.
